(19) United States
(12) Patent Application Publication
(10) Pub. No.: US 2011/0213878 A1
(43) Pub. Date: Sep. 1, 2011

(54) METHOD AND SYSTEM FOR MONITORING A SECURITY-RELATED SYSTEM

(75) Inventors: Harald Karl, Fuerth (DE); Roland Porsch, Speichersdorf (DE); Stefan Rothbauer, Allershausen (DE)

(73) Assignee: SIEMENS AKTIENGESELLSCHAFT, Muenchen (DE)

(21) Appl. No.: 12/994,974

(22) PCT Filed: Mar. 24, 2009
(86) PCT No.: PCT/EP2009/053401

§ 371 Date: Feb. 22, 2011

(30) Foreign Application Priority Data
May 28, 2008 (DE) 10 2008 025 489.4

(51) Int. Cl. G06F 15/173

(52) U.S. Cl. 709/224

(57) ABSTRACT

A system for monitoring a security-related system has a monitoring device on which a first process occurs. The monitoring device generates a monitoring result which is transmitted to another device that forms at least part of the security-related system. Accordingly, a second monitored process of the security-related system returns the received monitoring result to the first process for testing in order to calculate a processing result.

The invention relates to a method and system for monitoring at least one process, which is incorporated in a safety-related system, in particular in an electrical, electronic or programmable electronic (E/E/PE) system.

Apparatuses or installations quite frequently represent a danger to people. The risk here is frequently a function of the mode of operation of the respective apparatus or installation. Generally apparatuses or installations are controlled using electrical or electronic systems. Such (safety-related) systems are ultimately responsible for ensuring that people are not exposed to danger. Stringent safety requirements are therefore set for the safety-related systems, resulting for example from the risk that exists for the people involved. Therefore predefined standards, rules and/or directives are usually set, which the respective safety-related systems have to meet. One example of such a standard is EN 50128. This is a European standard for safety-related railway software and relates to railway applications relating to telecommunications technology, signal technology as well as data processing systems and software for railway control and monitoring systems.

In order to implement a safety functionality in safety related systems, it is necessary to demonstrate that all the components and modules involved in the safety functionality execute their respective functionality in a sufficiently reliable manner. In other words compliance with the predefined standards, rules and/or directives is necessary over all levels and layers of a system. This requires constant monitoring of the system and constant checking of the components, modules and processes involved in the safety functionality. Such monitoring is usually carried out within the framework of certification of the safety-related system. Certification demonstrates that all the predefined standards, in other words standards, rules and/or directives are complied with and that (end) results of the operations or processes carried out feature the necessary properties or those properties that correspond to the respective standard in the safety-related system.

In order to avoid potential error sources, until now both hardware and software have been configured in a minimalist manner, in other words reduced to the most essential, in this safety-related area. The operating systems are implemented specifically for the respective specific hardware. Account is taken here of restrictions relating to the embodiments of the operating systems, software and/or hardware.

The implemented operating systems are also oriented toward a specific application. If there was a desire for example to use an existing operating system for a further application, this would not be possible conventionally due to the very specific orientation of the corresponding operating system. There is also quite frequently a restriction to the components used, which are controlled within the framework of the corresponding operating system.

For example an operating system specified for aviation or for industrial applications has a very precisely defined functional scope. The operating system is designed for example for the needs of the aviation industry. Adaptation to a further field of deployment, such as the railway for example, is then not possible.

The architectures of the known safety-related systems are also characterized by the specificity of their components, operating systems and processes. If there should now be a wish to check or monitor such a very specifically structured safety-related system for its correct operation, monitoring is required, which is oriented precisely toward the specifically set up safety-related system and is embodied for this purpose.

There is therefore a need for generic certification of safety-related systems. This requires end to end certification, in other words certification that extends over all levels and layers of the safety-related system, in other words to operating system level. Such generic certification to operating system level, in other words the certification of hardware and software including the operating system, has not been known to date.

The object of the invention is to allow flexible and generic certification of safety-related systems.

The object is achieved by a method with the features of the independent claim 1, by an apparatus with the features of the independent claim 11, by a computer program with the features of the independent claim 12 or by a data medium with the features of the independent claim 14.

The invention creates a method for monitoring a safety-related system, the method featuring the following steps:
Transmitting a monitoring result of a first process from a monitoring apparatus, which is provided for monitoring the safety-related system, to an apparatus, which forms at least part of the safety-related system;
Evaluating the monitoring result by means of a second process, the second process forming a process of the safety-related system;
Calculating a processing result as a function of the monitoring result; and
Checking the calculated monitoring result.

To monitor the safety-related system, the first process is executed on the monitoring apparatus. The first process here is embodied such that the second process can be monitored by means of the first process, in other words the first process is embodied so that it can be checked by means of the first process whether the second process is operating correctly. It can be checked by means of the first process whether for example the second process supplies correct results, executes the correct operations, steps or functions and/or is still executed.

According to one advantageous embodiment the safety-based system can be made up of a number of layers, in other words at least one layer. The second monitored process in this instance is a process of one of the layers of the safety-related system. The safety-related system can feature for example at least one of the following layers:
an application layer, which can advantageously be embodied in such a manner that application-specific functions can be executed;
a middleware layer;
an operating system layer; or
a hardware layer.

A number of layers can be monitored in a bundled manner by a monitoring apparatus embodied advantageously in such a manner to monitor the safety-related system.

According to a further advantageous embodiment of the present invention an Open Source operating system, e.g. Linux, can be used as the operating system.

The use of an Open Source operating system allows flexible and generic certification of safety-related systems. Open Source operating systems (e.g. Linux) are freely available and of transparent configuration, in other words they offer an adaptable and reusable basis for the certification of safety-related systems.

The development of Open Source operating systems such as Linux is conducted in the public domain. As a result Open Source operating systems are subjected to a wide range of tests and meet predefined safety standards, while some specifically developed operating systems, which are not outwardly transparent, in many instances do not undergo such a test-intensive and safety conscious development. Therefore in addition to the advantages of adaptability and reusability, the use of Open Source operating systems often also has the advantage of meeting a high safety standard.

As well as using the entire Open Source operating system, in other words all the modules of the Open Source operating system, according to one advantageous embodiment it is also possible to select or define relevant modules of an Open Source operating system for an application and only to use these predefined modules of the Open Source operating system in the framework of a generically certified system. If for example Linux is used as the Open Source operating system, it is possible to use both the entire operating system as well as packages (modules) of the Linux operating system selected specifically (for the application). Such a preselection on the one hand avoids potential error sources and reduces the number of test and monitoring functions and on the other hand the storage space required for the modules of the Open Source operating system is reduced by the preselection. This allows flexible configuration of the certification of safety-related systems.

The safety-related system or the layers of the safety-related system, e.g. the layer of the Open Source operating system, is/are monitored by software developed specifically for this purpose. Monitoring processes, which are provided for monitoring processes of the safety-related system, (for example processes of the Open Source operating system incorporated wholly or partially in a safety-related system) are managed and initiated and results of the monitoring processes of at least one process of the safety-related system (e.g. of the Open Source operating system, when the layer of the operating system is monitored) are processed. The results of processing by means of processes of the safety-related system are checked, from which it is identified whether the safety-related system is working correctly or whether problems have arisen.

As mentioned above, according to the present inventive method a second process is monitored by means of a first process. The first process is thus of a higher ranking than the second process, thereby allowing specific certification of safety-related systems.

In one advantageous embodiment the first process is selected from a quantity of processes, which are stored in the apparatus embodied for monitoring purposes. This quantity of first processes or monitoring processes can be freely configured. The monitoring processes feature general monitoring processes, which allow the checking or verifying of general operations or processes of the safety-related system or the layers of the safety-related system (e.g. those of the Open Source operating system), and/or application-specific monitoring processes. This ensures flexibility in respect of the monitoring or certification of safety-related systems.

The processing of a monitoring result or challenge can also be expected within a predefined time. The processing of the monitoring result is then terminated and a new processing of the monitoring result by means of the second process is carried out, if the processing of the monitoring result has not taken place within the predefined time. There is therefore a further opportunity for monitoring, as it may be that a short-term overload has slowed the system and that no immediate intervention or measures are therefore necessary to avoid danger. Establishing whether the processing of the monitoring result has taken place within the predefined time can be carried out in the monitoring apparatus and/or in the monitored apparatus.

The processing result or response can be checked in the monitoring apparatus. The processing result is then transmitted beforehand from the monitored apparatus, which features the at least one module of the Open Source operating system, to the monitoring apparatus.

The processing of the monitoring result can also consist of applying a function of the monitored process to the monitoring result or challenge. In such an instance the processing result can correspond to the result of the function of the monitored process.

According to one embodiment of the present inventive method the checking of the processing result can include verification of the processing result by means of the first process.

The safety-related system can also be stopped, if the checking of the processing result shows that the processing result is wrong, in order to remove the safety-related system from possible danger.

According to one advantageous exemplary embodiment of the present invention what is known as a Safety and Environment Processor (SEP) can be used as the first monitored apparatus embodied for monitoring purposes. A main processor for example can be provided as the second apparatus, which features the at least one module of the Open Source operating system.

The invention further creates a system having an apparatus, which is embodied for monitoring a safety-related system and which is further embodied so that a monitoring result or challenge of a first process can be transmitted to a further apparatus, which forms at least part of the safety-related system, the further apparatus evaluating the monitoring result by means of a second process, which is a process of the safety-related system, and supplying a processing result or response.

The further apparatus can form part of the safety-related system or can even comprise the entire safety-related system.

The first process is preferably embodied so that the second process can be monitored by means of the first process, in other words the first process is of a higher ranking than the second process.

To monitor the safety-related system the first process is executed on the monitoring apparatus for monitoring a safety-related system.

As described above, the safety-related system can feature a number of layers. If a layer of the operating system is present, according to one advantageous embodiment of the inventive apparatus an Open Source operating system (such as Linux) can be used as the operating system.

In one embodiment of the inventive apparatus the apparatus for monitoring the safety-related system can feature a quantity of processes and be embodied so that the first process can be determined from the quantity of processes.

The apparatus can also advantageously be embodied so that the processing result or response can be checked. The first process within the framework of the check can be embodied in such a manner here that the processing result can be verified by means of the first process.

If the processing result or response is wrong, the apparatus for monitoring the safety-related system can advantageously be embodied so that the safety-related system can be stopped.

The apparatus for monitoring the safety-related system can also advantageously be embodied so that the processing result can be received from the further apparatus.

As described above, the apparatus for monitoring the safety-related system can be for example a Safety and Environment Processor (SEP). The further apparatus, which features at least part of the safety-related system, can be an MCP (Main Control Processor) or a main processor.

According to one advantageous exemplary embodiment of the present invention the apparatus can be embodied so that the monitoring result or challenge can be processed within a predefined time by means of the second process. The apparatus here can advantageously be embodied so that the processing of the monitoring result can be terminated and the monitoring result can be processed again by means of the second process, if the first result is not processed within the predefined time.

The second process can also advantageously be embodied so that a function of the second process can be applied to the monitoring result or challenge.

According to one advantageous exemplary embodiment of the present invention the apparatus, which features at least part of the safety-related system, can be embodied so that the processing result or response can be transmitted to the monitoring apparatus.

The abovementioned object is also achieved by a computer program, which features a coding, which is embodied so that the steps of the method outlined above and described in more detail below can be executed. The computer program here can be stored on a data medium according to one advantageous exemplary embodiment of the present invention. Finally the abovementioned object is also achieved by a data medium, which features the abovementioned computer program.

The software layer provided means that the inventive monitoring ensures continuous testing. Some of the checks or verifications of the correct operation of the safety-related system are carried out on separate hardware (such as watchdog or a Safety and Environment Processor (SEP)). The sufficiently complex requirements integrated in the monitoring processes ensure that both complete failure, i.e. when all system resources are bound or a memory overflow occurs, and also smaller errors of the safety-related system are probably identified (challenge—response, task monitoring, etc.).

The interaction of hardware (e.g. SEP) and software, which monitors the safety-related system, ensures adequate error discovery for the safety integrity stage (e.g. SIL 1).

The present invention further ensures that applications can be based on the functions made available by the operating system. The safety functionality does not therefore have to be protected in an application-dependent or applicative manner.

The invention is described in more detail below with reference to the exemplary embodiments illustrated in the accompanying drawing, in which:

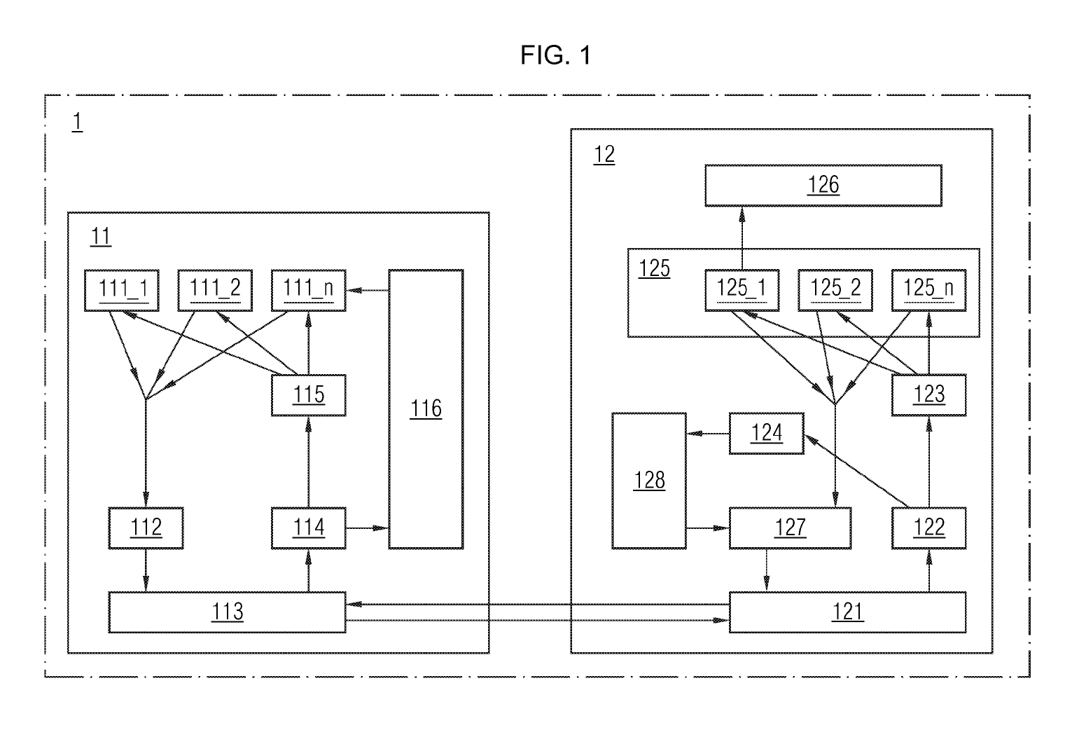

FIG. 1 shows a system for monitoring a safety-related system according to an exemplary embodiment of the present invention; and

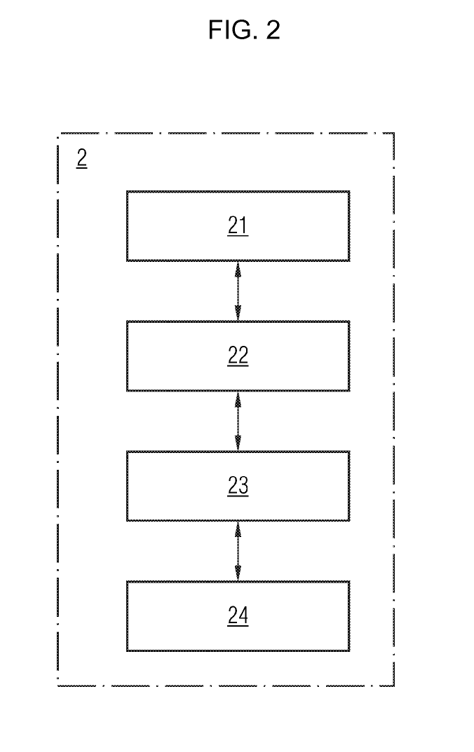

FIG. 2 shows a safety-related system, featuring a number of layers and monitored according to an exemplary embodiment of the present invention.

A system illustrated in FIG. 1 forms a system 1 for monitoring a safety-related system 2. An operating system layer here features at least one module of an Open Source operating system, which is incorporated in a safety-related system 2. The Open Source operating system is Linux according to the present exemplary embodiment. The safety-related system 2 may be an electrical, electronic or programmable electronic system (E/E/PE).

Also according to the present exemplary embodiment only certain modules of the entire Open Source operating system are present in the operating system layer of the operating system. These are modules, which are required for the safety-related system 2, to minimize safety-related risks by means of further modules that are not absolutely necessary. The entire Open Source operating system can also be used.

For a clearer and simpler illustration of the present invention the monitoring of the operating system layer is primarily described, in other words the monitoring of at least one Linux module. Further layers of the safety-related system 2 can also be monitored adequately. The safety-related system 2 can also be monitored independently of the layers.

According to the present exemplary embodiment the monitoring system 1 features two apparatuses 11 and 12, the apparatus 11 being a SEP (SEP: Safety and Environment Processor) or monitoring processor and being set up for monitoring at least one Linux module. The apparatus 12 is formed for example by a Main Control Processor MCP and at least one Linux module. The main control processor 12 is monitored by the SEP11.

The SEP 11 features a quantity of monitoring processes 111_1, 111_2 to 111_n, which are configured to monitor processes 125_1, 125_2 to 125_n of the Linux operating system. The monitoring processes 111_1, 111_2 to 111_n form higher-ranking processes of the Linux processes 125_1, 125_2 to 125_n.

According to the present exemplary embodiment each Linux process 125_1, 125_2 to 125_n to be monitored has a proxy or higher-ranking process 111_1, 111_2 to 111_n on the SEP 11 responsible for its monitoring. However this simple relationship should not be seen as restrictive. It is of course possible for at least one higher-ranking process or monitoring process 111_1, 111_2 to 111_n to monitor a number of Linux processes 125_1, 125_2 to 125_n and for a Linux process 125_1, 125_2 to 125_n to be monitored or validated by a number of monitoring processes 111_1, 111_2 to 111_n.

A monitoring process 111_1, 111_2 to 111_n first generates a monitoring result b or challenge (e.g. a number or other data structure). According to the present exemplary embodiment this monitoring result b is coded by a packet coder 112 and transmitted by way of an interface 113, e.g. a Universal Asynchronous Receiver Transmitter (UART), to an interface 121 of the MCP 12. The coded and transmitted monitoring result b is forwarded within the MCP 12 to a packet decoder 122. The packet decoder 122 decodes the result b of the monitoring process 111_1, 111_2 to 111_n or the monitoring result to a dispatcher 123. The dispatcher 123 then forwards the transmitted monitoring result b to the corresponding Linux process 125_1, 125_2 to 125_n to be monitored for processing.

It is possible to discover which Linux process 125_1, 125_2 to 125_n is monitored by which monitoring process 111_1, 111_2 to 111_n for example by transmitting an identifier (ID) of the corresponding monitoring process 111_1, 111_2 to 111_n together with the associated monitoring result b. The dispatcher 123 then also receives the corresponding ID of the Linux process 125 together with the monitoring result b and can forward the respective monitoring result b correctly to the addressed Linux process 125_1, 125_2 to 125_n.

In the present exemplary embodiment the Linux processes 125_1, 125_2 to 125_n are managed by a Linux Safety Manager (LSM) 125.

The corresponding Linux process 125_1, 125_2 to 125_n receives the result of the monitoring process 111_1, 111_2 to 111_n and processes this monitoring result b. This produces a further result, referred to in the following as the processing result a or response. Like the monitoring result b this processing result a can be for example a number or a further simple or complex data structure.

To process the monitoring result b the Linux process 125_1, 125_2 to 125_n can apply at least one predefined individual function. The monitoring result b is computed here by the function, in other words a function result of a predefined function is calculated as a function of the monitoring result b and buffered as the processing result a. The result of the execution of the at least one individual function can then serve as the processing result a.

The following example serves to clarify the production of the processing result a:

A monitoring process 111_n is selected by way of example from the quantity of monitoring processes for monitoring the MCP 12 and thus the Linux operating system. The monitoring process 111_n generates a number b as a result or monitoring result. The monitoring result b is received from a Linux process 125_n, since the monitoring process 111_n monitors the Linux process 125_n. The Linux process 125_n computes the number b with an individual function fn to produce a new result a. This processing result a is sent back to the monitoring process 111_n. The monitoring process 111_n then checks with the same individual function fn, whether the two results b and a match. If so, the safety-related system 2 is in a safe state. If not, corresponding measures are initiated to ensure safety, for example the safety-related system is stopped completely.

The LSM 125 is provided for safety-related functions on the level of the Open Source operating system, in this instance Linux. These functions also determine the execution of services of the safety-related system 2, which are controlled and offered by an application 126 of the services of the safety-related system 2. Therefore at least some Linux processes have access to and influence on the execution of services and applications 126 of the safety-related system 2, for example the Linux process 125_1 in FIG. 1. In this instance, when the Linux process 125_1 is tested or monitored, the execution of the respective service by the application 126 is tested and checked for safe operation at the same time. This allows certification through all the layers of a safety-related system 2.

When a processing result a is available, it is forwarded to a packet coder 127 of the MCP 12. The packet coder 127 codes the processing result a and forwards the coded processing result a to the interface 121 for transmitting and receiving data. This transmits the coded processing result a to the SEP 11, or to the interface 113 of the SEP. From there the coded processing result a passes to the packet decoder 114, is decoded there and forwarded to a dispatcher 115.

The dispatcher 115 assigns the processing result a to the corresponding monitoring process 111_1, 111_2 to 111_n. This can be done for example, as described above, by means of an ID transmitted at the same time.

The corresponding monitoring process 111_1, 111_2 to 111_n evaluates the received processing result a, for example by appropriate evaluation or by appropriate comparison of the monitoring result b and the processing result a.

If the evaluation of the processing result a by means of the monitoring process 111_1, 111_2 to 111_n is positive, the safety-related system 2 is in a safe state. Otherwise corresponding measures to protect the system are carried out. If necessary the SEP 11 of the monitoring system 1 prompts the complete stoppage of the safety-related system 2.

It can however happen that the MCP 12 is utilized to capacity. To cope with such a situation, a time period can be set for the processing of a monitoring result by means of a Linux process 125_1, 125_2 to 125_n, within which time period the processing of the monitoring result b has to take place. If the processing of the monitoring result b does not take place within the predefined time, provision can be made for a further processing attempt. The previous processing is terminated and a new processing of the monitoring result b is started. If the new processing does not produce a result either, the safety-related system 2 is made safe. In some instances the execution of the safety-related system 2 is simply terminated. This check can take place for example in the MCP 12 by means of the components SEP control 124 and a global safety control GSC 128. For monitoring purposes the SEP control 124 receives the corresponding ID of the monitoring process from the packet decoder 122, when the associated monitoring result arrives in the packet decoder 122. The organization of the transfer of the system 2 to a safe state can take place in the MCP 12 by means of the safety control 128.

According to the present exemplary embodiment the general safety control on the side of the SEP 11 is carried out by the component Global Safety Control (GSC) 116, which controls the execution of monitoring processes 111_1, 111_2 to 111_n and verifies the results of the Linux processes or processing processes. The organization of the transfer of the system to a safe state can take place in the SEP 11 by means of the GSC 116.

FIG. 2 shows a safety-related system 2, which features a number of layers 21, 22, 23, 24 and which is monitored according to an advantageous exemplary embodiment of the present invention. In the present exemplary embodiment the safety-related system 2 features an application layer 21, a middleware layer 22, which is for example a communication framework, an operating system layer 23, for example an Open Source operating system, and a hardware layer 24. The respective layers 21, 22, 23 can be monitored as set out above. Communication or an exchange of data also takes place between the layers, in other words the layers influence, coordinate, control and/or verify one another. This communication is shown by arrows between the layers in FIG. 2.

The safety-related system 2 here is present on a main processor for example. Monitoring is monitored by a monitoring apparatus, for example the abovementioned SEP 11.

If the application layer 21 is monitored, software modules or software processes of the application layer 21 can be monitored. It is ensured during monitoring that the applications are running correctly. It is possible to deduce from this that the layers below are functioning or operating correctly.

In this instance the SEP 11 features monitoring processes for example, which are set up for monitoring the application layer 21. The results or data of these monitoring processes are transmitted to the application layer 21 on the main processor and are processed there by the respective processes or modules of the application layer 21. The results or data produced by the processing are transmitted to the SEP 11 and checked or verified for correctness by the monitoring processes.

The monitoring of the middleware layer 22 can also be carried out in a similar manner.

The monitoring of the operating system layer 23 can also be carried out as described above.

Processes can also be monitored for example to determine whether they are still “live”. Looking at the Linux operating system, identifiers of the processes running on Linux can be transmitted to the monitoring apparatus 11 after the start of the safety-related system 2 or the operating system by means of the Linux “grep” command. The monitoring apparatus 11 can initiate such processes for example in a list or table. During ongoing operation of the safety-related system 2 it can then be monitored whether the Linux processes are still running as expected or whether the processes generally still exist, in other words are in particular in a “live” state.

The present invention therefore relates to the monitoring of a safety-related system 2, in particular an electrical, electronic or programmable electronic (E/E/PE) system. A first result b of a first process is transmitted here from a first apparatus 11, which is embodied for monitoring the safety-related system 2, to a second apparatus 12, which features at least part of the safety-related system 2. The first result b is processed by means of a second process, the second process being a process of the safety-related system 2. Processing produces a second result a. The second result a is then checked, to determine whether the second process is functioning correctly or is operated correctly and thus whether the safety-related system 2 is working correctly.

1-14. (canceled)

15. A method for monitoring a safety-related system, which comprises the steps of:
transmitting a monitoring result of a first process from a monitoring apparatus provided for monitoring the safety-related system, to an apparatus forming at least part of the safety-related system, the first process being determined from a quantity of processes stored in the monitoring apparatus;
evaluating the monitoring result by means of a second process, the second process forming a process of the safety-related system;
calculating a processing result in dependence on the monitoring result; and
checking the processing result calculated.

16. The method according to claim 15, wherein a predefined time is provided for evaluating the monitoring result.

17. The method according to claim 16, which further comprises:
terminating an evaluation of the monitoring result if the evaluation of the monitoring result does not take place within the predefined time provided; and
performing a new evaluation of the monitoring result by means of the second process.

18. The method according to claim 16, which further comprises carrying out a determination on whether the evaluation of the monitoring result has taken place within the predefined time in at least one of the monitoring apparatus or the apparatus of the safety-related system.

19. The method according to claim 15, wherein an evaluation of the monitoring result features an application of a predefined function of the second process to the monitoring result.

20. The method according to claim 15, which further comprises checking the processing result in the monitoring apparatus.

21. The method according to claim 20, which further comprises transmitting the processing result from the apparatus of the safety-related system to the monitoring apparatus.

22. The method according to claim 15, which further comprises checking the processing result by means of the first process.

23. The method according to claim 20, which further comprises stopping the safety-related system if a checking of the monitoring result shows that the processing result is wrong.

24. A system for monitoring a safety-related system, comprising:
a further apparatus forming at least part of the safety-related system; and
a monitoring apparatus on which a first process runs, the first process generating a monitoring result, which is transmitted to said further apparatus, a second monitored process of the safety-related system sending the monitoring result received for a calculation of a processing result back to the first process for checking, the first process being determined from a quantity of processes stored in said monitoring apparatus.

25. A computer-readable medium having computer-executable instructions for performing a method which comprises the steps of:
transmitting a monitoring result of a first process from a monitoring apparatus provided for monitoring a safety-related system, to an apparatus forming at least part of the safety-related system, the first process being determined from a quantity of processes stored in the monitoring apparatus;
evaluating the monitoring result by means of a second process, the second process forming a process of the safety-related system;
calculating a processing result in dependence on the monitoring result; and
checking a calculated processing result.

26. A data medium having computer executable instructions for performing a method which comprises the steps of:
transmitting a monitoring result of a first process from a monitoring apparatus provided for monitoring a safety-related system, to an apparatus forming at least part of the safety-related system, the first process being determined from a quantity of processes stored in the monitoring apparatus;
evaluating the monitoring result by means of a second process, the second process forming a process of the safety-related system;
calculating a processing result in dependence on the monitoring result; and
checking a calculated processing result.

27. A computer program, which comprises the steps of:
transmitting a monitoring result of a first process from a monitoring apparatus provided for monitoring a safety-related system, to an apparatus forming at least part of the safety-related system, the first process being determined from a quantity of processes stored in the monitoring apparatus;
evaluating the monitoring result by means of a second process, the second process forming a process of the safety-related system;
calculating a processing result in dependence on the monitoring result; and
checking a calculated processing result.
